(19) United States
(12) Patent Application Publication
(10) Pub. No.: US 2007/0153835 A1
(43) Pub. Date: Jul. 5, 2007

(54) Providing High Data Rates in DSL Systems Connected by Multiple Pairs of Wires

(75) Inventor: Himamshu Gopalakrishna Khasnis, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/306,545

(22) Filed: Jan. 1, 2006

(51) Int. Cl. H04J 1/02

(52) U.S. Cl. 370/493

(57) ABSTRACT

Providing high data rates in DSL systems connected by multiple pairs of wires. Data is transferred between user equipment at a customer premises and a central office using multiple pairs of wires, with one pair used for sending data in one direction and another pair used for sending data in the opposite direction. Simplex data traffic on each pair enables full allocation of the available bandwidth for data for transmitting in one pair and for receiving in the other pair, providing a high data rate. Overall hardware requirement and cost are reduced, and system performance is enhanced.

### BACKGROUND

1. Field of the Invention

The present invention relates generally to the field of communication systems and more specifically to a method and apparatus for providing high data rates in digital subscriber line (DSL) systems connected by multiple pairs of wires.

2. Related Art

Digital subscriber line (DSL) technology is often used to provide voice and data services using a pair of wires (e.g., twisted pair copper wires), as is well known in the relevant arts. Typically, the voice is carried on a small portion (0-4 KHz band) of the bandwidth spectrum available on the wire-pair, and portions of the remaining spectrum are conveniently used for carrying the data related signals. Specific bands of such portions are respectively allocated for the transmit direction and receive direction to facilitate full-duplex communication supporting data transfers.

There is a general need to provide high data rates using DSL technology. In general, the maximum data rate (bandwidth) that can be provided to a location is fixed by the specific DSL technology, distance and noise level. Thus, for a given location, higher data rates can be provided by using DSL technologies (e.g., SDSL, ADSL) which provide correspondingly high data rates. However, it may be desirable to provide higher data rates than that provided by a given DSL technology.

Multiple pairs of wires can be used to achieve such higher data rates, for example, by a technique referred to as bonding, as described now with respect to FIG. 1. FIG. 1 is a block diagram illustrating a prior approach to bonding in a DSL system using two pairs of wires connecting a customer premises equipment (CPE) with a central office (CO). The DSL system is shown containing modems 110, 120, 130, and 140, twisted-pair wires 114-1/114-2, and 123-1/123-2, matching impedances 114-3, 114-4, 114-5, 114-6, 123-3, 123-4, 123-5 and 123-6, and bonding blocks 150 and 160. Each component is further described below.

Bonding block 150 is located at a customer premises and receives data packets from and transmits data packets to a user equipment (not shown) on paths 151 and 152 respectively. Bonding block 150 receives packets on path 151 and distributes the packets on paths 153 and 156. Bonding block 150 also receives data packets on paths 154 and 155, and forwards these on path 152 to the user equipment.

Bonding block 160 is located at a CO and receives data packets from and transmits data packets to switching equipment(not shown) on paths 161 and 162 respectively. Bonding block 160 receives packets on path 161, and distributes the packets on paths 164 and 165. Bonding block 160 also receives data packets on paths 163 and 166, and forwards these on path 162 to switching equipment at the CO.

Modem 110 transmits data received on path 153 to modem 140 (located at a CO), and forwards on path 154 the data received from modem 140. Similarly, modem 120 transmits data received on path 156 to modem 130 (located at a CO), and forwards on path 155 the data received from modem 130. Modems 110 and 120 are located at a customer's premises and operate to modulate and demodulate data, perform necessary analog-to-digital and digital-to-analog conversions, 2 to 4 wire conversion and line driving, as is described below.

Modem 110 is shown containing modulator 110-1, digital-to-analog converter (DAC) 110-2, line driver 110-3, hybrid 110-7, low-noise amplifier (LNA) 110-6, analog-to-digital converter (ADC) 110-5 and demodulator 110-4.

Modulator 110-1 modulates a multi-tone signal (generated internally) with data received on path 153, and forwards the modulated signal to DAC 110-2. DAC 110-2 converts the received digital signal to an analog signal, which is forwarded to line driver 110-3. Line-driver 110-3 provides the necessary impedance matching and drive strength to the signal received from DAC 110-2, and drives the signal on twisted-pair wire 114-1/114-2.

Impedances 114-3 and 114-4(which are predominantly resistive) provide series termination on twisted-pair wire (114-1/114-2) for impedance matching. Hybrid 110-7 performs 2 wire to 4 wire conversion. As noted earlier, both receive and transmit data (signals) may be present simultaneously on twisted-pair wire 114-1/114-2. Hybrid 110-7 forwards receive signals (received on twisted-pair wire 114-1/114-2) to LNA 110-6, while sufficiently attenuating any transmit signals (present on twisted-pair wire 114-1/114-2). Hybrid 110-7 may include any necessary band-split filters.

LNA 110-6 amplifies a receive (analog) signal (received from hybrid 110-7) and forwards an amplified analog signal to ADC 110-5. ADC 110-5 converts the amplified analog signal to a digital signal, and forwards such digital signal to demodulator 110-4. Demodulator 110-4 demodulates the signal (received from ADC 110-5) to extract data, and forwards such data to bonding block 150.

Modem 120 operates in a manner similar to modem 110. Components 120-1, 120-2, 120-3, 120-7, 120-6, 120-5 and 120-4 operate similar to components 110-1, 110-2, 110-3, 110-7, 110-6, 110-5 and 110-4 described earlier, and their description is not repeated in the interest of conciseness. Similarly, components 123-3 through 123-6 and twisted-pair wire 123-1/123-2 operate in a manner similar to components 114-3 through 114-6 and twisted-pair wire 114-1/114-2.

Modem 140 transmits data from switching equipment (not shown) at the CO to modem 110 (located at the customer premises) and receives data from modem 110 and forwards such data to switching equipment at the CO. Similarly, Modem 130 transmits data from switching equipment at the CO to modem 120 (located at the customer premises) and receives data from modem 130 and forwards such data to switching equipment at the CO.

Modems 140 and 130 are located at the CO and operate similar to modem 110 described above. Thus, the set of components 140-1, 140-2, 140-3, 140-7, 140-6, 140-5 and 140-4 in modem 140, and the set of components 130-1, 130-2, 130-3, 130-7, 130-6, 130-5 and 130-4 in modem 130 respectively operate similar to components 110-1, 110-2, 110-3, 110-7, 110-6, 110-5 and 110-4 described earlier, and their description is not repeated in the interest of conciseness.

Receive and transmit data streams between CPE and CO are each split into two receive and transmit data streams. One such receive and transmit data stream (full-duplex)is propagated on path represented by twisted-pair wire 114-1/114-2, and the other receive and transmit data stream (full-duplex) is propagated on path represented by twisted-pair wire 123-1/123-2.

Thus, by using multiple wire-pairs and distributing the packets for transmission on the two pairs as described above, a higher data rate is provided.

However, the above described approach to providing high data rates has some drawbacks.

For example, in the system described above, two transmitters and two receivers are needed at each end (CPE and CO), and 2 to 4 wire conversion is needed requiring the use of hybrids. Thus, overall cost of the system is high.

Since transmit and receive signals are present on each path, the hybrids have to mitigate any interference between transmit and receive signals and. Further, 2 wire to 4 wire conversion may cause problems due to echoes. Maximum data rates are constrained by the amount of interference rejection and echo-cancellation that may be achievable. Further, the line drivers in such a system have to drive series impedances (predominantly resistive) and therefore consume more power.

Therefore, what is required is a method and apparatus for providing high data rates in a DSL system using multiple pairs of wires, which overcomes at least some of the drawbacks of the approach described above.

### BRIEF DESCRIPTION OF THE DRAWINGS

The present invention will be described with reference to the following accompanying drawings, which are described briefly below.

FIG. 1 is a block diagram illustrating a prior approach to providing high data rates in DSL systems connected by multiple pairs of wires.

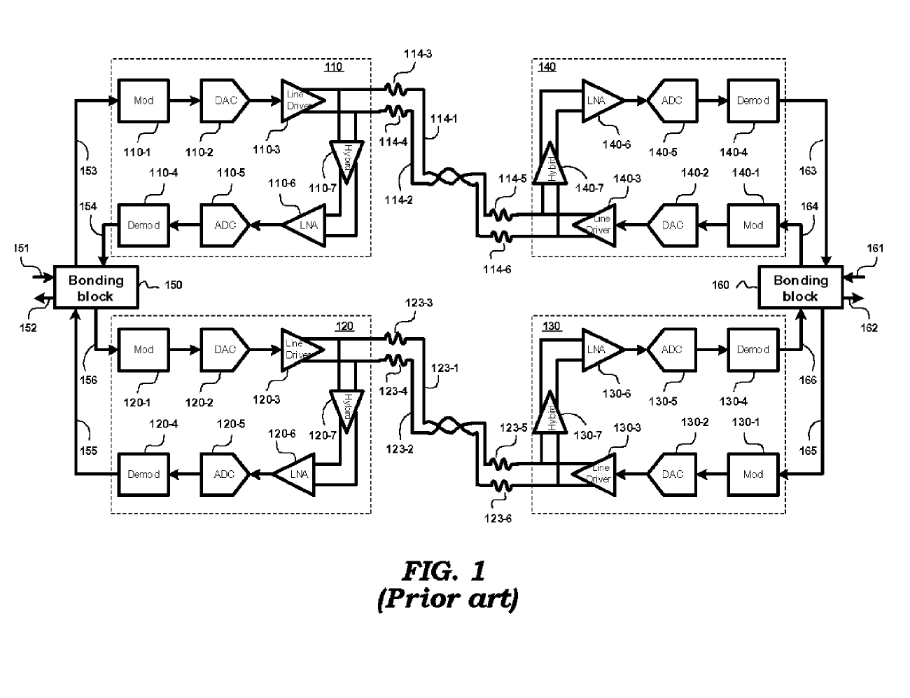

FIG. 2 is a block diagram illustrating an approach to providing high data rates in DSL systems according to an aspect of the present invention.

FIG. 3 is a block diagram of an example environment in which various aspects of the present invention can be implemented.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention uses one pair of wires for transmitting data bits in one direction and another pair of wires for transmitting data bits in the reverse direction according to DSL technology. Due to such simplex data traffic on each pair, the available bandwidth for data transfers can potentially be fully allocated for transmitting in one pair and for receiving in the other pair, providing a high data rate.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2. Invention

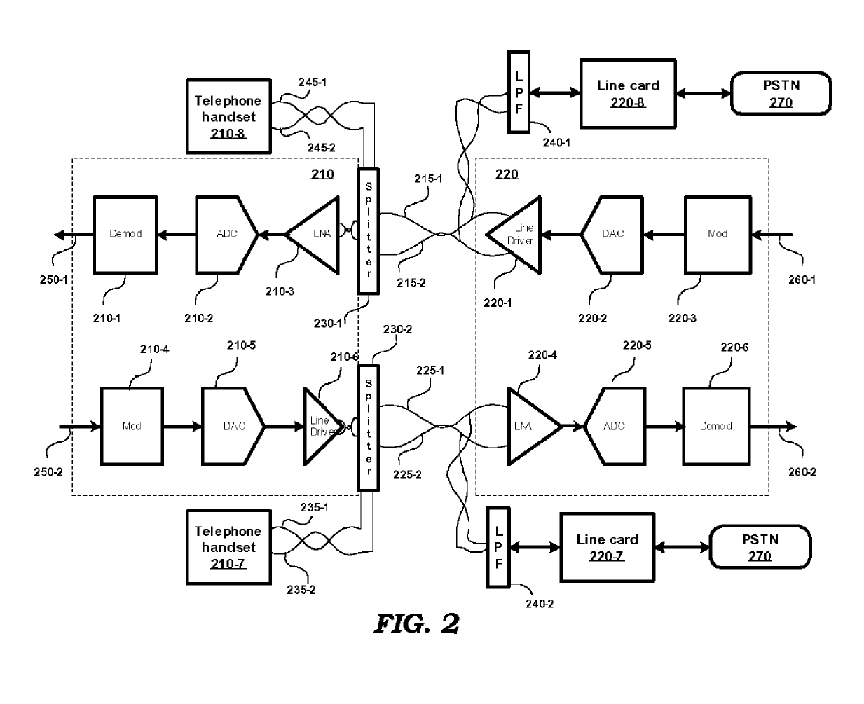

FIG. 2 is a block diagram illustrating the manner in which higher data rates may be provided according to an aspect of the present invention. The block diagram is shown containing modem 210, modem 220, twisted-pair wires 215-1/215-2 and 225-1/225-2, telephone handsets 210-8 and 210-7, low-pass filters (LPF) 240-1 and 240-2, line cards 220-8 and 220-7 and PSTN network 270.

Broadly, the block diagram shows a connection between a CPE and a CO using two pairs of wires, one pair being used for data in one direction and the other pair for data in the opposite direction. Each of such wire pairs may carry voice traffic in both directions. The components of FIG. 2 are described in further detail below.

Modem 210 is located at a customer's premises and operates to transfer data between a user equipment (connected to paths 250-1/250-2, not shown) and a CO. Modem 210 is shown containing modulator 210-4, DAC 210-5, line driver 210-6, LNA 210-3, ADC 210-2 and demodulator 210-1.

Modulator 210-4 modulates a multi-tone signal (generated internally) with data received on path 250-2 from the user equipment, and forwards the modulated signal to DAC 210-5. DAC 210-5 converts the received digital signal to an analog signal, which is forwarded to line driver 210-6. Line-driver 210-6 provides the necessary impedance matching and drive strength to the signal received from DAC 210-5, and drives the signal on twisted-pair wire 225-1/225-2 through splitter 230-2. Telephone handset 210-7 operates as a normal telephone used for voice communications and connects to equipment at the CO through splitter 230-2.

Splitter 230-2 provides a low pass filter for all voice traffic originating from and destined to telephone handset 210-7, and provides a high pass filter to data traffic received from line driver 210-6. Thus splitter 230-2 isolates the telephone from the high power signals in the DSL frequencies and ensures that the low frequency high voltage ring tones, voice signals from the telephone do not interfere in the DSL operation (i.e modem 210).

Similarly, splitter 230-1 provides a low pass filter for all voice traffic originating from and destined to telephone handset 210-8, and provides a high pass filter to data traffic destined to LNA 210-3. Thus splitter 230-1 isolates the telephone from the high power signals in the DSL frequencies and ensures that the low frequency high voltage ring tones, voice signals from the telephone do not interfere in the DSL operation (i.e modem 210).

LNA 210-3 amplifies a signal (analog signal containing data) received on twisted-pair wire 215-1/215-2 (through splitter 230-1) and forwards an amplified analog signal to ADC 210-2. ADC 210-2 converts the amplified analog signal to a digital signal, and forwards such digital signal to demodulator 210-1. Demodulator 210-4 demodulates the digital signal received from ADC 210-5 to extract data, and forwards the extracted data to user equipment(not shown) on path 250-1.

Modem 220 is located at a CO and operates to transfer data between a switching device (not shown) at the CO and a user equipment(not shown) at a customer's premises. Modem 220 is shown containing modulator 220-3, DAC 220-2, line driver 220-1, LNA 220-4, ADC 220-5 and demodulator 220-6.

Twisted-pair wire 215-1/215-2 are tapped at the CO end and connected to a low pass filter(LPF) 240-1, which in turn is connected to line card 220-8. Signals to (from) line card 220-8 from (to) twisted-pair wires 215-1/215-2 are low pass filtered and thus voice traffic may be forwarded from (and received on) line card 220-8. Line card 220-8 provides a connection to the public switched telephone network (PSTN) 270.

Modulator 220-3 modulates a multi-tone signal (generated internally) with data received on path 260-1 from switching equipment (not shown) at the CO, and forwards the modulated signal to DAC 220-2. DAC 220-2 converts the received digital signal to an analog signal, which is forwarded to line driver 220-1. Line-driver 220-1 provides the necessary impedance matching and drive strength to the signal received from DAC 220-2, and drives the signal on twisted-pair wire 215-1/215-2. Since data signals output by line-driver 220-1 are present at a higher frequency band(as per DSL specifications), such signals do not get coupled to line card 220-8 due to the presence of LPF 240-1.

Twisted-pair wire 225-1/225-2 are tapped at the CO end and connected to a low pass filter(LPF) 240-2, which in turn is connected to line card 220-7. Signals to(from) line card 220-8 from(to) wires 225-1/225-2 are low pass filtered and thus voice traffic may be forwarded from (and received on) line card 220-7. Line card 220-7 provides a connection to the public switched telephone network (PSTN) 270.

LNA 220-4 amplifies a signal received on twisted-pair wire 225-1/225-2 and forwards an amplified analog signal to ADC 220-5. Any voice signal present at the input of LNA 220-4 is either low-pass filtered (using filter not shown) or removed at a later stage. ADC 220-5 converts the amplified analog signal to a digital signal, and forwards such digital signal to demodulator 220-6. Demodulator 220-6 demodulates the digital signal received from ADC 220-5 to extract data, and forwards such data to switching equipment (not shown) at the CO on path 260-2.

Twisted-pair wires 215-1/215-2 and 225-1/225-2 carry voice and data in different frequency bands. Voice may be carried in a lower band (example, 0 to 4 kilohertz) and data in a higher frequency band (example, 26 kilohertz to 1 megahertz).

As may be appreciated from the operation of the components described above, separate transmit and receive paths are used for data in each direction. Twisted-wire pair 215-1/215-2 is used for transferring data from the CO to the customer premises, and twisted-wire pair 225-1/225-2 is used for transferring data from the customer premises to the CO. Thus, simplex transmission is used for data in each wire pair. Voice traffic may however be present in both directions on twisted-pair wires 215-1/215-2 and 225-1/225-2.

Bandwidth available in each wire pair for data transfer is fully allocated for data transfer in a particular direction. By having multiple pair of wires, one for data in one direction, and another for data in the opposite direction, the effective data transfer rate can be doubled, thus providing high data rates.

Since the above technique does not need 2 wire to 4 wire conversion, there is no requirement to use hybrids. Further, in comparison with the prior approach described earlier, the present invention requires only one transmitter and one receiver at each end (CO and customer premises). Thus, overall cost due to hardware is reduced.

Since there is no requirement for a 2 wire to 4 wire conversion, echoes can be substantially reduced, additional echo-cancellation equipment is not needed, and overall system performance is increased.

Further, as there are no series impedances (predominantly resistive), the line drivers can operate at half the power when compared to the prior approach.

Thus, high data rates can be provided using multiple pairs of wires (one pair for transmitting data bits in one direction and another pair of wires for transmitting data bits in the reverse direction) according to DSL technology.

Separate transmit and receive paths for data eliminate the need for hybrid equipment (needed for 2 wire to 4 wire conversion) and for bandsplit filters, thereby reducing overall hardware requirement (and thus the cost) at customer premises and central office. (The only filters required are those needed to separate data from voice traffic).

The need for series impedances is eliminated (as there is no 2 to 4 wire conversion), thus allowing the line drivers in the system to transmit at half the power compared to systems using 2 to 4 wire conversion. Further, separate transmit and receive paths for data greatly reduce data integrity problems due to echoes, thus increasing system performance and reliability.

Modems 210 and 220 thus designed can be implemented in various environments. An example environment is described below in further detail.

3. Example Environment

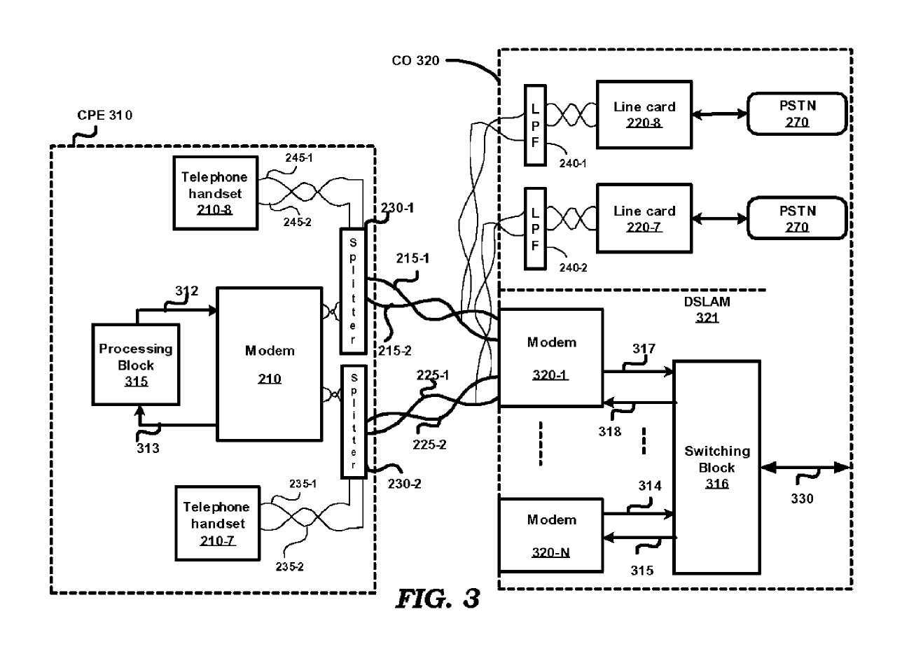

An example environment in which various aspects of present invention are implemented is described below with reference to FIG. 3. Shown there is a block diagram containing a customer premises equipment (CPE) 310 and equipment at CO 320 containing DSL Access Multiplexer (DSLAM) 321 connected according to DSL technology by twisted wire pairs 215-1/215-2 and 225-1/225-2, and low-pass filters (240-1/240-2) and line cards (220-7/220-8). Each element is described below in further detail.

CPE 310 is located at a customers premises (home, office etc) and may include a computing device such as a desktop computer and telephone handsets. CPE 310 is shown containing processing block 315, modem 210, telephone handsets 210-8 and 210-7 and splitters 230-1 and 230-2.

Processing block 310 generates data (on path 312) that need to be transmitted to DSLAM 321, and receives data (on path 313) from DSLAM 320. Processing block 315 may correspond to a central processing unit CPU on a desktop computer.

Typically, user applications running on processing block 315 generate such data that needs to be transmitted to DSLAM 320. For example, the data may be generated by an application such as a web browser that needs to communicate with a web server (not shown). Processing block 310 also receives data from DSLAM 321. Such data may correspond to information downloaded from a web page contained in a web server (not shown).

Modem 210 and modem 320-1 operate to transfer data on wire pairs 215-1/215-2 and 225-1/225-2, and can be implemented as described above with respect to FIG. 2. DSLAM 321 resides in a central office (CO), and serves as a switch to provide connectivity between various subscribers (such as CPE 310) connected to it.

DSLAM 320 operates to provide connectivity between various CPEs connected to it, and is shown containing switching block 316 and modems 320-1 through 320-N. Modems 320-2 through 320-N may connect to other CPE (connections not shown)at other customer premises and operate similar to modem 320-1. Similarly, line cards and LPFs similar to those shown in FIG. 3 may be present for (associated with) each of such connections.

Switching block 316 switches data received on path 330 to the appropriate modem 220-1 to 220-N, on paths corresponding to 318 to 315. Switching block 316 also forwards data received from modems 220-1 (on 220-N on paths corresponding to 317 to 314 ) to other devices (such as routers etc)connected to path 330.

Data transfer between CPE 310 and DSLAM 321 is done using modems 210 and 320-1.

Modem 210 transmits data to modem 320-1 on wire pair 215-1/215-2 (through splitter 230-1). Modem 210 receives data from modem 320-1 on wire pair 225-1/225-2 (through splitter 230-2). Simplex communication for data is used on each wire pair 215-1/215-2 and 225-1/225-2.

LPF 240-1/240-2 and line cards 220-8/220-7 operate in a manner similar to as in FIG. 2 and their operation is nit repeated here.

High data rates are achievable using multiple pairs of wires (one pair for transmitting data bits in one direction and another pair of wires for transmitting data bits in the reverse direction) according to DSL technology.

4. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of providing a high data transfer rate between a first equipment and a second equipment using a digital subscriber line (DSL) technology, said method comprising:
transmitting data bits from said first equipment to said second equipment on a first pair of wires using said DSL technology; and
transmitting data bits from said second equipment to said first equipment on a second pair of wires using said DSL technology;
wherein said first pair of wires carries data in a first band of frequencies and said second pair of wires carries data in a second band of frequencies;
said first band of frequencies in said first pair of wires is fully allocated for said transmitting data bits from said first equipment to said second equipment; and
said second band of frequencies in said second pair of wires is fully allocated for said transmitting data bits from said second equipment to said first equipment.

2. The method of claim 1, wherein said first pair of wires carries voice in a third band of frequencies, which does not overlap with said first band of frequencies.

3. The method of claim 2, wherein said first band of frequencies is identical to said second band of frequencies.

4. The method of claim 3, wherein said first equipment comprises a customer premises equipment (CPE) and said second equipment is located in a central office (CO).

5. A modem transferring data to another modem using a digital subscriber line (DSL) technology, said modem comprising:
a first interface circuit transmitting data bits to said another modem on a first pair of wires using said DSL technology,
wherein said first pair of wires carries data in a first band of frequencies, and
said first band of frequencies in said first pair of wires is fully allocated for said transmitting data bits.

6. The modem of claim 5, wherein said modem further comprises a second interface circuit receiving data bits from said another modem on a second pair of wires using said DSL technology,
wherein said second pair of wires carries data in a second band of frequencies, and
said second band of frequencies in said second pair of wires is fully allocated for receiving data bits.

7. The modem of claim 6, wherein said first pair of wires carries voice in a third band of frequencies, which does not overlap with said first band of frequencies.

8. The modem of claim 7, wherein said first band of frequencies is identical to said second band of frequencies.

9. The modem of claim 8, wherein said modem is contained in a customer premises equipment (CPE) at a customer's location and said another modem is located in a DSLAM at a central office (CO).
